(19) United States
(12) Patent Application Publication
(10) Pub. No.: US 2004/0225530 A1
(43) Pub. Date: Nov. 11, 2004

(54) Displaying hierarchical service health of a network over time

(76) Inventors: Mark Adam Bell, Fort Collins, CO (US); Craig Alan Ehlke, Fort Collins, CO (US); Ellen Maureen Nelson, Laporte, CO (US); Bruce Votipka, Fort Collins, CO (US)

Correspondence Address: AGILENT TECHNOLOGIES, INC., Legal Department, DL429, Intellectual Property Administration, P. O. Box 7599, Loveland, CO, 80537-0599, US

(21) Appl. No.: 10/431,433

(22) Filed: May 8, 2003

(51) Int. Cl. G06F 17/60

(52) U.S. Cl. 705/2

(57) ABSTRACT

Health events for nodes of a hierarchical service structure of nodes of a network are aggregated in accordance with an algorithm to thereby determine health states of the nodes. Icons representing the determined health states are displayed on a display device. The icons being displayed as an array indicating hierarchical service health of the network over time.

### BACKGROUND OF THE INVENTION

1. Field of the Invention

The present invention relates to displaying hierarchical service health of a network over time.

2. Description of the Related Art

A computer network can be used to provide many different types of services.

To ensure that the services are operating properly, the network is typically monitored to observe service health. There are also techniques to monitor service health over time.

Unfortunately, conventional monitoring techniques do not provide a way to view hierarchical service health of a network over time.

### SUMMARY OF THE INVENTION

Accordingly, the present invention displays hierarchical service health of a network over time.

More specifically, the present invention provides a method which includes displaying hierarchical service health of a network over time on a display device.

The present invention also provides a method including (a) aggregating health events for nodes of a hierarchical service structure of nodes of a network in accordance with an algorithm to thereby determine health states of the nodes; and (b) displaying icons representing the determined health states, the icons being displayed as an array indicating hierarchical service health of the network over time.

Further, the present invention provides a method including (a) selecting, by an end user, a total time; (b) selecting, by the end user, a time period, the total time being divided by the time period into time intervals; (c) selecting, by the end user, an algorithm; (d) selecting, by the end user, respective nodes of a hierarchical service structure of nodes of a network; (e) selecting, by the end user, a ranking order; (f) for each time interval, aggregating health events for the selected nodes in accordance with the selected algorithm to thereby determine health states of the selected nodes, respectively; and (g) displaying icons representing the determined health states of the selected nodes, the icons being displayed in the selected ranking order as an array indicating hierarchical service health of the network over time.

The present invention also provides an apparatus for displaying health of a network having a hierarchical service structure of nodes, health events for nodes of the hierarchical service structure being aggregated in accordance with an algorithm to thereby determine health states of the nodes. The apparatus includes a screen display displaying icons representing the determined health states, the icons being displayed as an array indicating hierarchical service health of the network over time.

### BRIEF DESCRIPTION OF THE DRAWINGS

The invention will become apparent and more readily appreciated from the following description of the preferred embodiments, taken in conjunction with the accompanying drawings of which:

FIG. 1 is a flow chart illustrating a process for displaying hierarchical service health of a network over time, according to an embodiment of the present invention.

FIG. 2 is a flow chart illustrating a process for displaying hierarchical service health of a network over time, according to an additional embodiment of the present invention.

FIG. 3 is a diagram illustrating a screen display illustrating the use of algorithms to aggregate health events, according to an embodiment of the present invention.

FIG. 4 is a diagram illustrating an example of a hierarchical service structure of nodes of a network, according to an embodiment of the present invention.

FIG. 5 is a diagram illustrating an example display of a hierarchical service health of a network over time, where the network has the hierarchical service structure of nodes in FIG. 4, according to an embodiment of the present invention.

FIG. 6 is a diagram illustrating an example of a screen display displaying a hierarchical service structure of nodes of a network, according to an embodiment of the present invention

FIG. 7 is a diagram illustrating an example of a screen display displaying a hierarchical service health of a network having the hierarchical service structure of nodes in FIG. 6, according to an embodiment of the present invention.

FIG. 8 is a diagram illustrating an example of a screen display displaying a hierarchical service health of a network having the hierarchical service structure of nodes in FIG. 6, according to an additional embodiment of the present invention.

FIG. 9 is a diagram illustrating a system architecture, according to an embodiment of the present invention.

### DESCRIPTION OF THE PREFERRED EMBODIMENTS

Reference will now be made in detail to the present preferred embodiments of the present invention, examples of which are illustrated in the accompanying drawings, wherein like reference numerals refer to like elements throughout.

Services provided by a network can be arranged in a hierarchical service structure of nodes as a service model. At the lowest level in the hierarchical service structure are actual measurements taken. The parent of the measurements is a test that takes the measurements, and so on up to the root of the hierarchical service structure. A hierarchical service structure can be configured to reflect different aspects of the network infrastructure, or different aspects of a business using or implementing the network. For example, the hierarchical service structure can have branches that include services by their geographical locations, or branches that contain services that are dedicated to their customers. The concept of a hierarchical service structure is known, and would be understood from U.S. Pat. 6,138,122, issued Oct. 24, 2000, which is incorporated herein by reference. Examples of hierarchical service structures will be described further below.

Typically, measurements are taken of network services, to ensure that the services are operating properly. When a measurement passes a specific threshold, a health event occurs. There may be many different possible health events for a specific type of measurement. For example, first, second and third health events may occur as a measurement passes first, second and third thresholds, respectively. For example, the health state may be given as “green” (e.g., good), “yellow” (e.g., cautionary) and “red” (e.g., critical) as the measurement passes first, second and third thresholds, respectively. The concept of a health event is known.

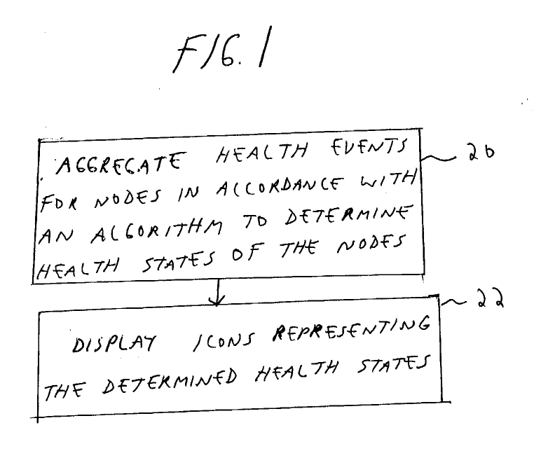

FIG. 1 is a flow chart illustrating a process for displaying hierarchical service health of a network over time, according to an embodiment of the present invention. Referring now to FIG. 1, in operation 20, health events for nodes of a hierarchical service structure of nodes of a network are aggregated in accordance with an algorithm to thereby determine health states of the nodes. The use of an algorithm will be discussed in more detail further below.

From operation 20, the process moves to operation 22, where icons representing the determined health states are displayed. The icons are displayed, for example, as an array indicating hierarchical service health of the network over time.

In various embodiments of the present invention, an end user may be able to select various display options. For example, the end user may be able to select a total time for which health history will be displayed, a time period of a time interval of the total time, an algorithm for aggregating the health events and/or a ranking order for displaying the health of the network.

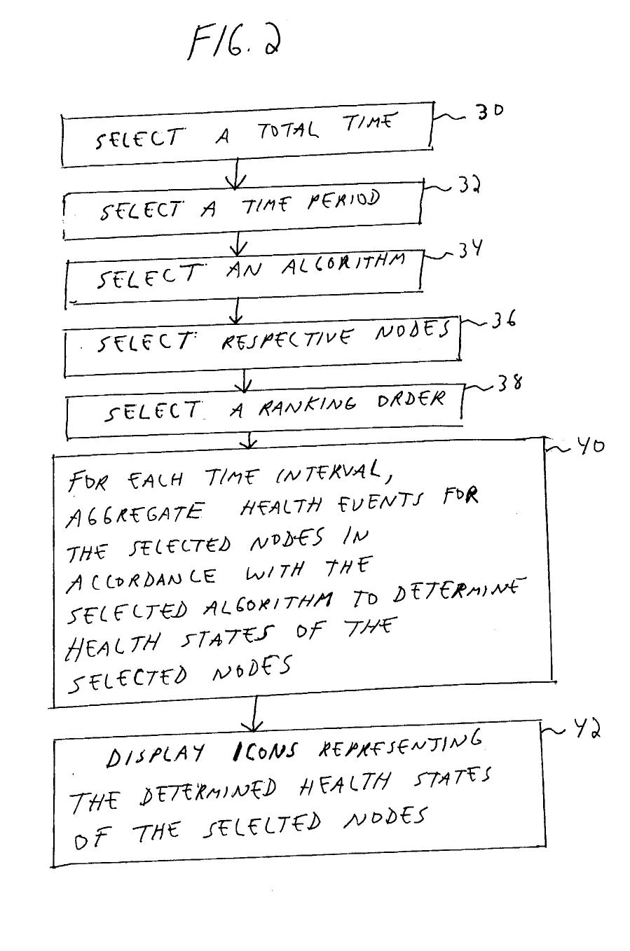

For example, FIG. 2 is a flow chart illustrating a process for displaying hierarchical service health of a network over time, according to an additional embodiment of the present invention. Referring now to FIG. 2, in operation 30, an end user selects a total time for which health history will be displayed. For example, the end user might select the total time to be one week. Of course, the present invention is not limited to any specific amount of time.

From operation 30, the process moves to operation 32, where the end user selects a time period for an interval of the total time. The total time is then divided by the selected time period into time intervals. As an example, the end user might select the time period of an interval to be one day. Therefore, if the total time for which the health history will be displayed is one week, and the selected time period is one day, then the one week total time will be divided into one day time intervals. Of course, the present invention is not limited to any specific time period, time intervals or total time.

From operation 32, the process moves to operation 34, where the end user selects an algorithm for aggregating health events. The use of an algorithm will be discussed in more detail further below.

From operation 34, the process moves to operation 36, where the end user selects respective nodes of the hierarchical service structure of nodes for which the end user desires to display a health state.

From operation 36, the process moves to operation 38, where the end user selects a ranking order (i.e., ranking algorithm) and, in some embodiments, also a ranking period, for displaying the health of the network. More specifically, the ranking order indicates an order in which health states will be displayed such as, for example, in the order the nodes were selected, or in order of severity over the ranking period.

From operation 38, the process moves to operation 40, where, for each time interval, health events for the selected nodes are aggregated in accordance with the selected algorithm to thereby determine health states of the selected nodes, respectively.

From operation 40, the process moves to operation 42, where icons representing the determined health states of the selected nodes are displayed. The icons are displayed in the selected ranking order as, for example, an array indicating hierarchical service health of the network over time. For example, the selected ranking order might indicate that icons representing health states of nodes be displayed in the original order in which the end user selected the nodes. As an additional example, the selected ranking order might indicate that icons represent health states be displayed in order of severity, and possibly over a user selected ranking period. There are many other possible ranking orders, and the present invention is not limited to any particular ranking order.

In various embodiments of the present invention, operations 30, 32, 34, 36 and/or 38 may be included or omitted. More specifically, in various embodiments of the present invention, an end user may or may not be provided with the ability to select the various items in the various operations. Therefore, the present invention is not limited to each of these operations being performed.

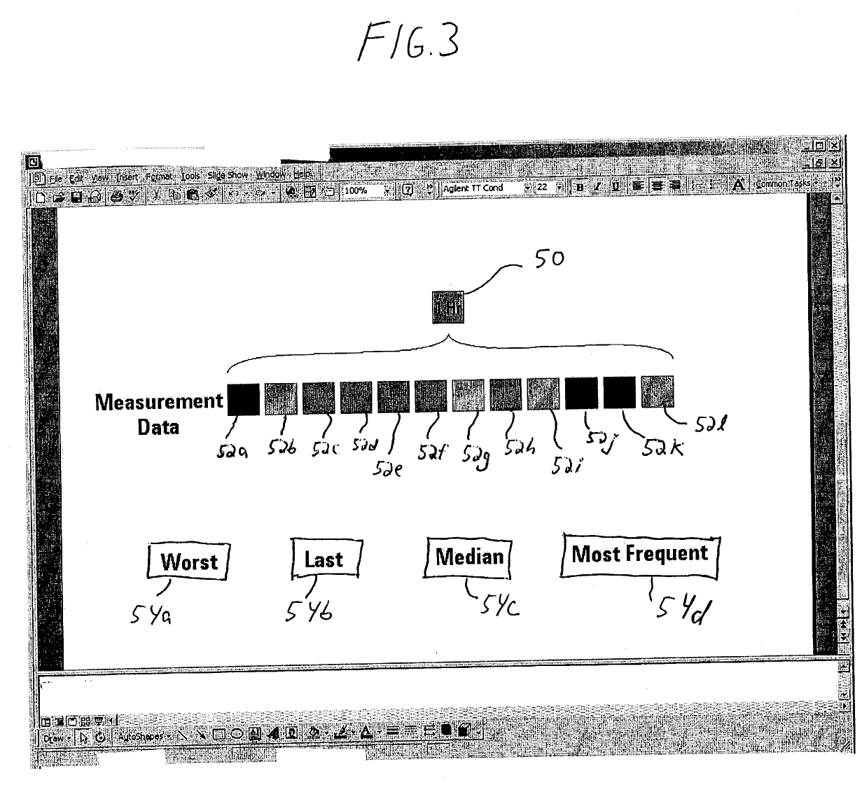

FIG. 3 is a diagram illustrating a screen display illustrating the use of algorithms to aggregate health events, according to an embodiment of the present invention. Referring now to FIG. 3, in this example, a time interval 50 is one hour. Therefore, the total time for which health history will be displayed might be for example, one day or one week. This total time will be divided into one hour time intervals for display purposes.

As shown in FIG. 3, many different measurement data 52a through 52l are taken. In this specific example, measurement data are taken in five (5) minute intervals, so that twelve (12) intervals 52a through 52l will be taken during the one (1) hour time interval. It is well-known how to take measurement data, and the present invention is not limited to any specific manner of taking measurement data or any specific intervals at which measurement data are taken. As shown in FIG. 3, each time interval is color coded (indicated by different shading in the figure) to indicate a health event represented by the measurement.

In this example, an end user can select among the following algorithms: worst 54a (i.e., the most severe health event within a time interval), last 54b (i.e., the last health event within a time interval), median 54c (i.e., the statistical median of the health events within a time interval) and most frequent 54d (i.e., the most frequent health event within a time interval). If worst 54a is selected as an algorithm, then the worst health event indicated by measurement data 52a through 52l will be used as the health state of the one hour time interval 50. For example, if a color “red” represents the worst health event shown by measurement data 52a through 52l, then the color “red” will be used as the health state of the one hour time interval 50.

If last 54b is selected as an algorithm, then the last health event indicated by measurement data 52a through 52l will be used as the health state of the one hour time interval 50. For example, if measurement data 52l represents the last taken measurement, than the health event of measurement data 52l will be used as the health state of the one hour time interval 50. For example, if a color “green” represents the health event shown by measurement data 52l, then the color “green” will be used as the health state of the one hour time interval 50.

If median 54c is selected as an algorithm, then the median health event indicated by measurement data 52a through 52l will be used as the health state of the one hour time interval 50. For example, if a color “green” represents the median health event shown by measurement data 52a through 52l, then the color “green” will be used as the health state of the one hour time interval 50.

If most frequent 54d is selected as an algorithm, then the most frequent health event indicated by measurement data 52a through 52l will be used as the health state of the one hour time interval 50. For example, if a color “yellow” represents the most frequent health event shown by measurement data 52a through 52l, then the color “yellow” will be used as the health state of the one hour time interval 50.

There are many different algorithms which can be used to aggregate health events, and the present invention is not limited to any particular algorithm. Moreover, in various embodiments of the present invention, an end user may be allowed to customize, or create, an algorithm, instead of selecting from a predetermined algorithm, to aggregate health events.

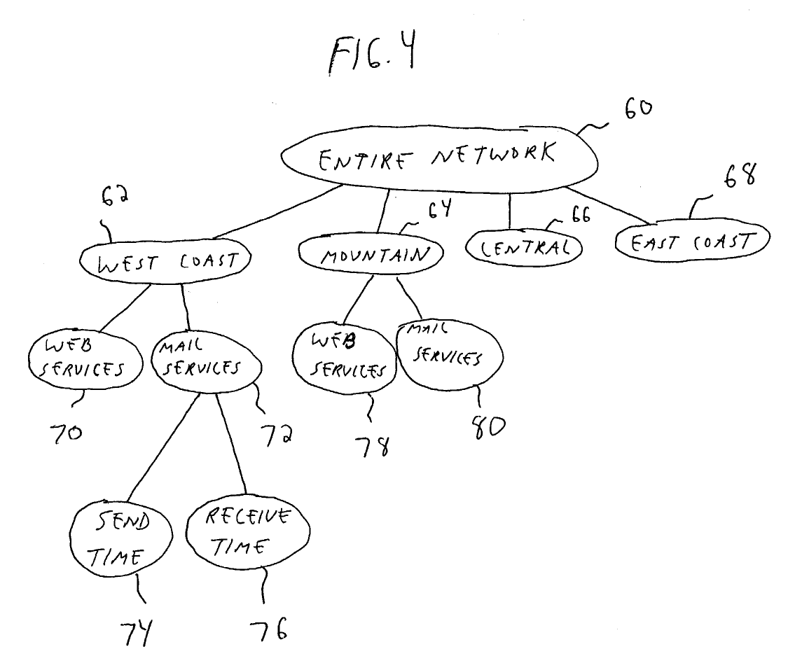

FIG. 4 is a diagram illustrating an example of a hierarchical service structure of nodes of a network, according to an embodiment of the present invention. In this example, the hierarchical service structure of nodes is for a network which geographically spans the continental United States. Referring now to FIG. 4, in this example, an entire network node 60 represent a root node of the hierarchical service structure. West coast node 62, mountain node 64, central node 66 and east coast node 68 are child nodes of entire network node 60. A web services node 70 and a mail services node 72 are child nodes of west coast node 62. A send time node 74 and a receive time node 76 are child nodes of mail services node 72.

FIG. 4 also shows a web services node 78 and a mail services node 80 being child nodes of mountain node 64. FIG. 4 shows only a partial structure of a possible hierarchical service structure of node for explanation purposes. For example, there would likely be nodes connected to central node 66, east cost node 68, etc. Moreover, it should be understood that FIG. 4 represents only an example, and the present invention is not limited in any manner to this specific structure or the specific shown nodes. Instead, there are many possible variations of a hierarchical service structure, and which would be applicable to the present invention.

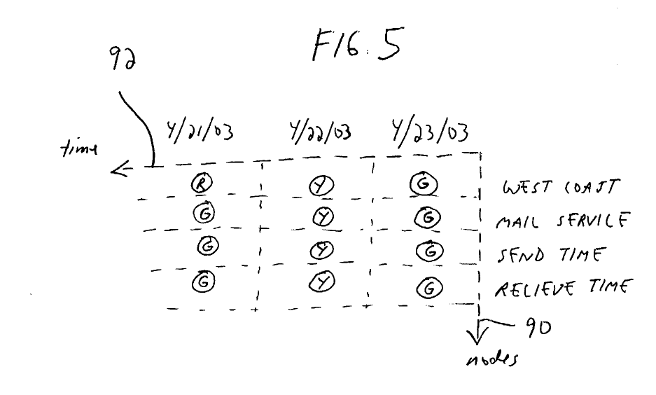

FIG. 5 is a diagram illustrating an example display of a hierarchical service health of a network over time, where the network has the hierarchical service structure of nodes in FIG. 4, according to an embodiment of the present invention. In the example of FIG. 5, it is assumed that the time interval is one day, and the total time for which health history will be displayed is the three day period of Apr. 21, 2003, through Apr. 23, 2003. In this example, the display has a node axis 90 and a time axis 92. At the intersection of each node and time, an icon is displayed. The icons represent the health states determined in accordance with an algorithm, as described above, for the respective nodes at the corresponding times. In the example, each icon would be displayed in a corresponding color representing a health state. For example, an icon might have a color of red, yellow or green, represented by R, Y and G, respectively, in FIG. 5, to indicate a health state. Thus, the icons form an array indicating the hierarchical service health of the network over time.

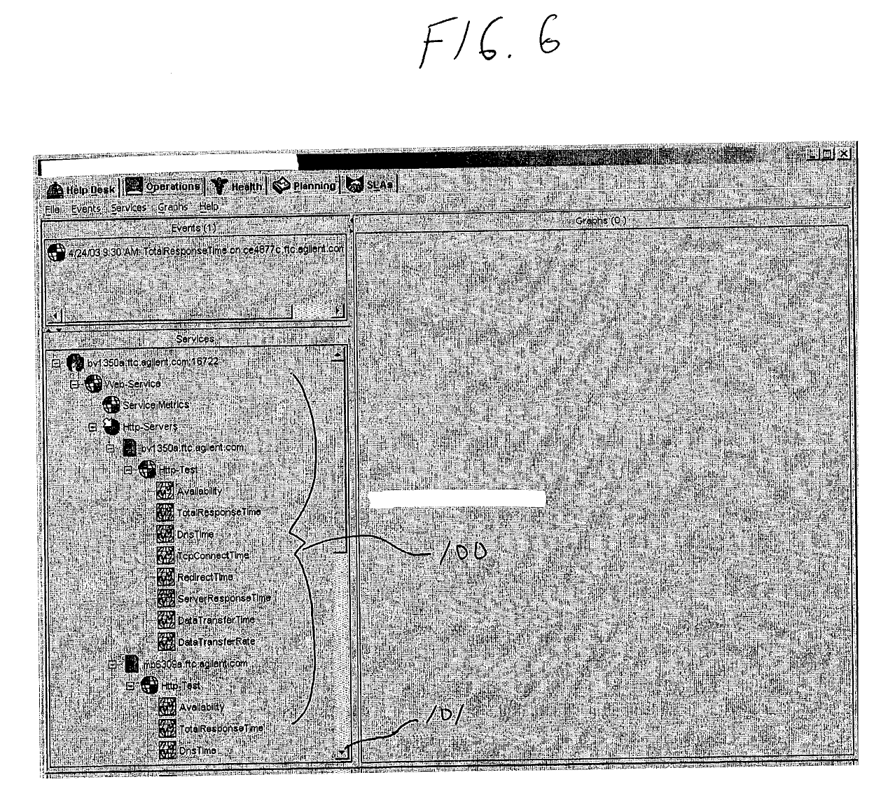

FIG. 6 is a diagram illustrating an example of a screen display displaying a hierarchical service structure of nodes of a network, according to an additional embodiment of the present invention. Referring now to FIG. 6, nodes 100 are arranged in a hierarchical service structure. FIG. 6 shows only a partial listing of the nodes in the hierarchical service structure. Arrow 101 can be used to scroll down to view additional nodes in the hierarchical service structure.

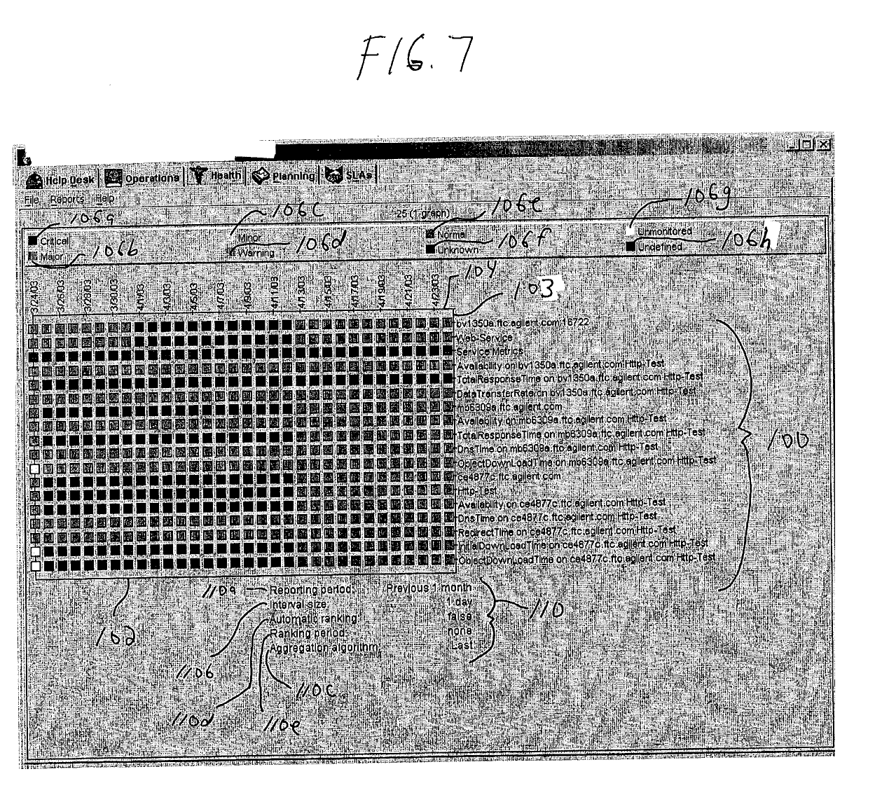

FIG. 7 is a diagram illustrating an example of a screen display displaying a hierarchical service health of a network having the hierarchical service structure of nodes in FIG. 6, according to an embodiment of the present invention. As illustrated in FIG. 7, an array 102 of icons has a node axis 103 listing various nodes 100 selected from the hierarchical service structure of nodes, and a time axis 104 showing the time intervals. Various of the nodes shown in FIG. 7 are not displayed in FIG. 6, and would be seen by scrolling with arrow 101 in FIG. 6.

In the example of FIG. 7, the icons in array 102 have a color corresponding to the various health states of critical 106a, major 106b, minor 106c, warning 106d, normal 106e, unknown 106f, unmonitored 106g and undefined 106h.

The screen display in FIG. 7 includes a legend 110 indicating a reporting period 110a (i.e., a total time for which health history will be displayed) of one month, an interval size 110b (i.e., a time interval) of one day, and an aggregation algorithm 110c of “last” (corresponding, for example, to the algorithm “last” 54b in FIG. 3).

Legend 110 also indicates an automatic ranking 110d of “false”, which, in this example, indicates that the end user has not selected a ranking order for displaying the icons. Since automatic ranking is not selected, legend 110 indicates a ranking period 110e of “none”.

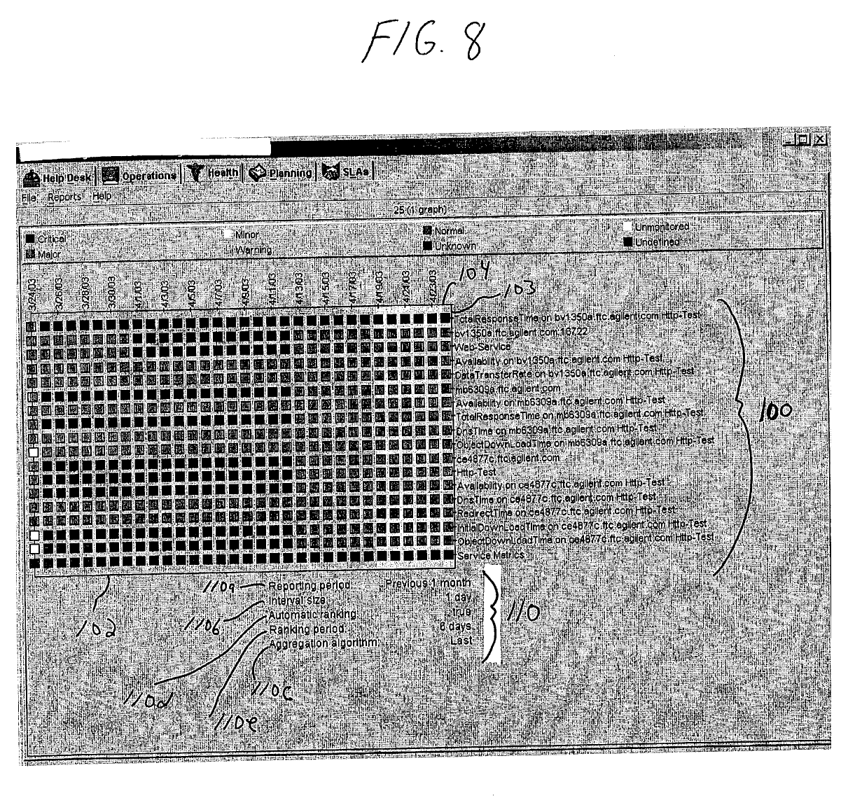

FIG. 8 is a diagram illustrating an example of a screen display displaying a hierarchical service health of a network having the hierarchical service structure of nodes in FIG. 6, according to an additional embodiment of the present invention.

FIG. 8 is similar to FIG. 7, except that automatic ranking 110d is “true” in FIG. 8, indicating that the end user has selected that the icons be displayed in accordance with some type of ranking order. For example, in this example, the icons are displayed in an order of severity over a ranking period, with the most severe health states displayed higher in array 102. In FIG. 8, legend 110 indicates a ranking period 110e of six days, indicating that the hierarchical service health of the network over time is displayed in accordance with severity over the most recent six days.

In various embodiments of the present invention, the end user may have the ability to select a ranking order (i.e. ranking algorithm) and a ranking period. There are many different ranking orders which can be used. For example, the ranking order might indicate that the node having the highest number of the most severe health states over the ranking period be displayed at the top, etc. Such a ranking order might be referred to as an “Olympic” order (or “Olympic” algorithm) where the most gold medals are on top, if tied for gold, then consider silver, etc. Of course, the present invention is not limited to any specific ranking order or any specific ranking period.

In various embodiments of the present invention, health propagates up the hierarchical service structure of nodes, and the displayed icons change as the health propagates upward, to thereby indicate the upward propagation of health. For example, a simple propagation algorithm would be that a more severe health state propagates upward to the next highest node. Therefore, in such a propagation algorithm, the health of children nodes determine the health of the parent nodes all the way up to the root node of a hierarchical service structure of nodes. For example, if the lowest node in a hierarchical service structure of nodes has the most severe health state, the health state of this lowest node would propagate up all the way to the root node. For example, if the color “red” indicated the worst health state, and the icon for the lowest node was “red”, then the icon for each higher node in the branch including the lowest node would also turn “red”. For example, in FIG. 4, if an icon representing the health state of receive time node 76 was “red”, than the mail services node 72, the west coast node 62 and the entire network node 60 in FIG. 4 would turn “red”. There are many different propagation algorithms that could be used to propagate the health upward, and the present invention is not limited to any particular propagation algorithm.

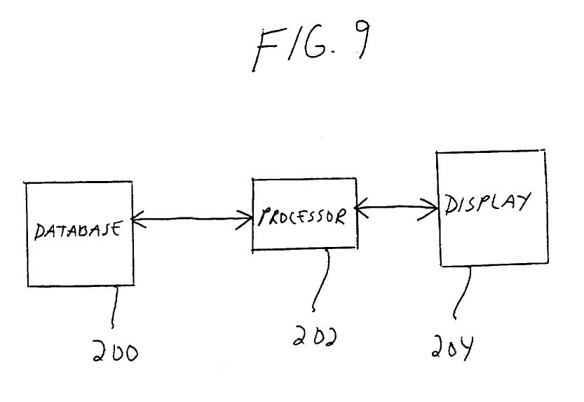

FIG. 9 is a diagram illustrating a system architecture, according to an embodiment of the present invention. Referring now to FIG. 9, a database 200 stores data indicating health events. A processor 202 accesses database 200 to perform operations such as those described herein, to display hierarchical service health of a network on display 204. There are many different system architectures which can be used to implement the present invention, and the present invention is not limited to any specific system architecture.

According to the above, the present invention allows an end user to envision network health over time. The end user can flexibly control how the data is processed and viewed, enabling the end user (typically a network operator) to determine how to prioritize tasks when network service failures occur.

According to the above, in various embodiments of the present invention, an end user can view the health over time for both network services and the service hierarchy simultaneously. This allows an end user to easily see the health relationships of network services within their hierarchy. For example, an end user can see the health relationships between a web measurement, a corresponding web server, and all web servers over a one month period, broken down into four-hour periods. Further, the present invention allows an end user to control how individual health events within a time interval are aggregated. This level of control is important for end users to determine how to respond to service problems.

According to the above, in various embodiments of the present invention, the present invention translates existing discrete service health event information into continuous service health history at, for example, end user-specified intervals. To do this, various embodiments of the present invention examine health events for the services specified by the end user, and translate these discrete health events into health states over fixed-size time intervals. In various embodiments, each time interval has a size specified by the end user, and the end user also provides the total amount of time to be included in the health history display. For each time interval, the present invention analyzes the health events that occurred in that time interval and, using one of a variety of algorithms, aggregates the health events into a continuous health state for that time interval. The present invention provides for multiple algorithms to be used to determine the health state. These algorithms include, for example, worst, most frequent, last and median. End users may also provide a custom aggregation algorithm.

According to the above, in various examples, a graphical display represents health information using a row-column oriented array. Each column represents, for example, a time interval. Each row represents, for example, a service measurement or higher-level node in a hierarchical service structure of nodes of the network. The intersection of each row and column includes a graphical element (i.e., an icon), which might be, for example, a square box, whose color indicates a health state for the time interval and that service node. Of course, the present invention is not limited to an icon being any particular type of icon or any particular shape. Moreover, the present invention is not limited to the use of color to indicate a health state. For example, a numerical value may be used to indicate a health state. Moreover, the present invention is not limited to time being in the columns and nodes being in the rows. Instead, for example, such information might be reversed, or other type of display arrangements can be provided.

In various embodiments of the present invention, an end user would be able to use a mouse to click on a service health point to navigate to a graph containing actual measurement values contributing to the health state.

According to the above, possible health states are determined by the underlying measurement system and its thresholding system. There many be many different possible health states. For example, in FIGS. 7 and 8, there are eight (8) different health states 106a through 106h. However, the present invention is not limited to any particular number of health states.

According to the above, the present invention provides an ability to keep a history of service health and to turn that information from a discrete set of health events into a linear contiguous representation of time.

According to the above, service health can be displayed in a number of ways that make it easy to access the health of the hierarchical service structure or specific parts of the hierarchical service structure. This includes intervalizing the health of a node into specified time intervals and ranking the health of different nodes based on the health of those intervals.

The present invention relates to displaying hierarchical service health of a network over time. As would be understood from the disclosure herein, a display of hierarchical service health refers to a display of indicators (such as, for example, icons) of health states in a hierarchical arrangement. As shown in various figures, such a hierarchical service health is displayed over time, and corresponds to a hierarchical service structure of nodes of the network.

The present invention relates to an end user. An end user is a person that accesses the method or apparatus of the present invention to view the hierarchical system health of a network. The end user might be, for example, a network operator, a system administrator or other person in charge of maintaining or monitoring the network. However, the end user is not limited to any particular person having any particular job responsibility.

Various different arrays of icons are disclosed herein. However, the present invention is not limited to any particular type or shape of array. Generally, an array is simply an orderly arrangement of icons.

Various different time periods, time intervals, and total times are disclosed herein. However, the present invention is not limited to any particular time periods, time intervals, and/or total times.

Various types of icons are disclosed herein. However, the present invention is not limited to any particular types, shapes and/or colors of icons.

Various different flow charts are disclosed herein. However, it should be understood that the order of operations, and the specific operations included in the respective flow charts, are only intended as examples. Many variations are possible. The present invention is not limited to any specific operations, or an specific order of operations.

Although a few preferred embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A method comprising:
displaying hierarchical service health of a network over time on a display device.

2. A method as in claim 1, wherein the hierarchical service health of the network is determined in accordance with health events occurring for a hierarchical service structure of nodes of the network.

3. A method as in claim 1, wherein the hierarchical service health of the network over time is displayed as an array of icons representing health.

4. A method as in claim 2, wherein the hierarchical service health of the network over time is displayed as an array of icons indicating health states of nodes of the hierarchical service structure of nodes, respectively, the array having a time axis and a node axis.

5. A method as in claim 4, wherein health propagates up the hierarchical service structure of nodes, and the displayed icons change as the health propagates up to thereby indicate the upward propagation of health.

6. A method as in claim 2, further comprising:
selecting, by an end user, a total time for which hierarchical service health of the network will be displayed;
selecting, by the end user, a time period, the total time being divided by the time period into time intervals;
selecting, by the end user, an algorithm; and
for each time interval, aggregating health events for nodes of the hierarchical service structure of nodes in accordance with the selected algorithm to thereby determine health states of the nodes, respectively, wherein said displaying displays icons representing the determined health states.

7. A method as in claim 2, further comprising:
aggregating health events for nodes of the hierarchical service structure of nodes in accordance with an algorithm to thereby determine health states of the nodes, respectively, wherein said displaying displays icons representing the determined health states.

8. A method as in claim 7, wherein the algorithm is selected by an end user.

9. A method as in claim 2, wherein a total time is divided into time intervals, the method further comprising:
for each time interval, aggregating health events for nodes of the hierarchical service structure of nodes in accordance with an algorithm to thereby determine health states of the nodes, respectively, wherein said displaying displays icons representing the determined health states.

10. A method as in claim 9, wherein the algorithm is selected by an end user.

11. A method as in claim 9, wherein at least one of the total time and a time period of the time intervals is selected by an end user.

12. A method as in claim 7, further comprising:
selecting a ranking order by an end user, wherein said displaying displays the icons in accordance with the selected ranking order.

13. A method as in claim 4, wherein the end user selects which nodes for which health states will be displayed.

14. A method comprising:
aggregating health events for nodes of a hierarchical service structure of nodes of a network in accordance with an algorithm to thereby determine health states of the nodes; and
displaying icons representing the determined health states, the icons being displayed as an array indicating hierarchical service health of the network over time.

15. A method as in claim 14, wherein the algorithm is selected by an end user.

16. A method as in claim 14, wherein
a total time is divided into time intervals,
said aggregating comprises, for each time interval, aggregating health events for nodes of the hierarchical service structure of nodes in accordance with the algorithm to thereby determine health states of the nodes, respectively; and
at least one of the total time and a time period of the time intervals is selected by an end user.

17. A method as in claim 16, wherein the algorithm is selected by the end user.

18. A method as in claim 14, further comprising:
selecting a ranking order by an end user, wherein said displaying displays the icons in accordance with the selected ranking order.

19. A method as in claim 14, wherein an end user selects the nodes for which health states will be displayed.

20. A method comprising:
selecting, by an end user, a total time;
selecting, by the end user, a time period, the total time being divided by the time period into time intervals;
selecting, by the end user, an algorithm;
selecting, by the end user, respective nodes of a hierarchical service structure of nodes of a network;
selecting, by the end user, a ranking order;
for each time interval, aggregating health events for the selected nodes in accordance with the selected algorithm to thereby determine health states of the selected nodes, respectively; and
displaying icons representing the determined health states of the selected nodes, the icons being displayed in the selected ranking order as an array indicating hierarchical service health of the network over time.

21. An apparatus comprising:
means for aggregating health events for nodes of a hierarchical service structure of nodes of a network in accordance with an algorithm to thereby determine health states of the nodes; and
means for displaying icons representing the determined health states, the icons being displayed as an array indicating hierarchical service health of the network over time.

22. A apparatus for displaying health of a network having a hierarchical service structure of nodes, health events for nodes of the hierarchical service structure being aggregated in accordance with an algorithm to thereby determine health states of the nodes, the apparatus comprising:
a screen display displaying icons representing the determined health states, the icons being displayed as an array indicating hierarchical service health of the network over time.
